(19) United States
(12) Patent Application Publication
(10) Pub. No.: US 2015/0381507 A1
(43) Pub. Date: Dec. 31, 2015

(54) NETWORK CONTROL APPARATUS

(71) Applicant: HITACHI, LTD., Tokyo (JP)

(72) Inventors: Chie MASUDA, Kawasaki (JP); Seishi HANAOKA, Tokyo (JP); Seiya KUDOH, Tokyo (JP)

(73) Assignee: HITACHI, LTD., Tokyo (JP)

(21) Appl. No.: 14/749,145

(22) Filed: Jun. 24, 2015

(30) Foreign Application Priority Data
Jun. 26, 2014 (JP) 2014-130884

(51) Int. Cl. H04L 12/835; H04L 12/26; H04L 12/801; H04L 12/851

(52) U.S. Cl. CPC H04L 47/30; H04L 47/2483; H04L 43/0894; H04L 47/11

(57) ABSTRACT

A network control apparatus is configured to acquire packets sent from a first network node to a second network node, manage packet types of the packets, monitor condition of a network between the first network node and the second network node based on the packets, and delay a specific packet in reaching the second network node based on an order of procedures determined based on packet types in the second network node when the condition of the network is assessed as worse than normal.

### CLAIM OF PRIORITY

The present application claims priority from Japanese patent application JP2014-130884 filed on Jun. 26, 2014, the content of which is hereby incorporated by reference into this application.

### BACKGROUND

This invention relates to packet processing in a network system or a network apparatus.

In recent years, terminals including smartphones have been provided with more applications and services that automatically communicate with servers on the terminals at high frequency. Such services and applications that frequently communicate with servers are concerned about putting a heavy load on a mobile network with increased control signaling in connecting to and disconnecting from the network.

Actually, there is a report of an incident in Japan that frequent communications of a large number of terminals caused concentration of control signals on an authentication server, resulting in an overflow, so that communications were not available for three hours and were difficult for subsequent 1.5 hours all over the country.

Mobile telecommunication carriers continue a huge investment in facilities to cope with increased control signaling in connecting to and disconnecting from the network. However, saving the facility investment is demanded; a study is necessary to reduce the load of signaling to the mobile network at the peak time of communication traffic.

In many network apparatuses, multiple processes are performed using a common queue for simplification in configuration and efficiency in memory usage. Such a configuration however allows accumulation of a specific type of packets in the queue with increase of the aforementioned signaling, so that processing the other types of packets sharing the queue might be delayed.

To cope with this problem, there is an existing technique that a network apparatus that has detected congestion includes a congestion notification signal in a packet and a network apparatus in receipt of the packet controls the output order of packets based on the congestion notification signal by outputting a packet without a congestion notification signal first if such a packet without a congestion signal follows the signal with a congestion notification signal (for example, refer to JP 2001-177575 A).

There is another existing technique to change the precedence of packets in which, if a port detects a flooding frame (multicast/broadcast frame), a network apparatus controls the transfer order of frames with reference to the internal precedence values stored in the frames (for example, refer to JP 2012-120015 A).

### SUMMARY

The technique of JP 2001-177575 A is effective when packets with a congestion notification signal and packets without a congestion notification signal are coming in mixture. However, when packets with a congestion notification signal are coming successively, the output order cannot be changed, so that the congestion is not relieved.

In contrast, the criterion in JP 2012-120015 A to enable the control is detection of a flooding frame (multicast/broadcast frame). Accordingly, the control works even if packets with a congestion notification signal come successively. However, when multiple burst transmissions are generated, like in a case where a flooding frame triggers a next flooding frame (multicast/broadcast frame), which triggers another next flooding frame (multicast/broadcast frame), and continues to still another next flooding frame (multicast/broadcast frame), the control of JP 2012-120015 A cannot determine which flooding frame is to be preceded. For this reason, it might take a considerable time to reduce the load on the network apparatus.

The following is an example of a situation where the control proposed in JP 2012-120015 A might take a considerable time to reduce the load on the network apparatus.

The example assumed here is a situation where after all mobility management entities (MMEs) in a pool get down, one of the MMEs has recovered. The term pool means an area where a UE terminal can move without changing the MME in charge of control processing for the mobile network.

FIG. 1 illustrates a sequence of processing performed under the above-described situation. After recovery of an MME, a plurality of base stations eNBs almost simultaneously start S1_SETUP procedures for establishing a link between an eNB and the MME, as illustrated in FIG. 1. An eNB that has completed the S1_SETUP procedure emits a signal for the UE in the cell. The UE that has received the signal simultaneously starts an Attach procedure (registration to the wireless access system). As noted from FIG. 1, the subsequent Attach procedure is triggered by the S1_SETUP procedure.

FIG. 2 illustrates details of the two kinds of procedures illustrated in FIG. 1; a plurality of procedures are started simultaneously in each kind. As noted from FIG. 2, an S1_SETUP procedure is completed with two messages; however, an Attach procedure is completed when 48 messages are completed. In the situation of this example, required control is to limit the initial S1_SETUP procedures and to finish the Attach procedures which come after completion of S1_SETUP procedures. In other words, control depending on the order of packet processing is required. The control according to JP 2012-120015 A, however, limits both of the S1_SETUP procedures and the Attach procedures; it takes a considerable time to relieve the load on the MME.

Not only in the above-described case where different kinds of procedures are successive but also in the case where only one kind of procedures are successive, the control according to JP 2012-120015 A might take a considerable time to reduce the load on the network apparatus. An example of such a case is described in the following.

The example assumed here is a situation where a massive number of Attach procedures are requested. FIG. 3 illustrates a sequence of an Attach procedure. In terms of the load by the messages in the Attach procedure to the MME, the MME processes fourteen messages until the end of the Attach procedure. That is to say, the MME completes an Attach procedure by receiving and processing the first to the fourteenth messages within the time window assigned to finish the Attach procedure. When massive messages arrive at the MME to cause processing load to the MME, preceding the fourteenth messages among the first to the fourteenth messages accumulated in the queue of the MME leads the MME to complete the Attach procedures sooner. In other words, required is to control the order of message processing included in packet processing procedure.

If the criterion to enable the control is detection of a flooding frame (multicast/broadcast frame) like in JP 2012-120015 A, the control limits both of the first messages and the fourteenth messages; as a result, completing the Attach procedures will take a considerably long time, compared to the case where the fourteenth messages are preceded.

A representative example of the present invention is a network control apparatus is configured to acquire packets sent from a first network node to a second network node, manage packet types of the packets, monitor condition of a network between the first network node and the second network node based on the packets, and delay a specific packet in reaching the second network node based on an order of procedures determined based on packet types in the second network node when the condition of the network is assessed as worse than normal.

An embodiment of the present invention achieves controlling the load to a mobile network apparatus when the load is increased.

The problems, configurations, and advantageous effects other than those described above are clarified in the following description of embodiments.

### BRIEF DESCRIPTION OF THE DRAWINGS

FIG. 1 is a diagram illustrating a sequence when an MME recovers from a failure;

FIG. 2 is a diagram illustrating a detailed sequence when an MME recovers from a failure;

FIG. 3 is a diagram illustrating a sequence of an Attach procedure;

FIG. 4 is a diagram illustrating an example of a hardware configuration of a network control apparatus in Embodiment 1;

FIG. 5 is a block diagram illustrating an example of a system in Embodiment 1;

FIG. 6 is an example of a monitoring result table in Embodiment 1;

FIG. 7 is an example of a table storing packet processing names, message names, and message processing numbers in Embodiment 1;

FIG. 8 is a flowchart of an example of overall processing of the network control apparatus in Embodiment 1;

FIG. 9 is a flowchart of an example of processing to seek optimum values for the service rate of a special queue and the maximum queue length for the special queue in the network control apparatus in Embodiment 1;

FIG. 10 illustrates an example of a table storing packet processing names, message names, and message processing numbers in Embodiment 2; and

FIG. 11 is a diagram illustrating an example of a system in Embodiment 3.

### DETAILED DESCRIPTION OF THE EMBODIMENTS

Hereinafter, embodiments of this invention are described in detail using the drawings.

The following description is provided in a plurality of sections or embodiments as necessary for convenience; however, they are not irrelevant to one another unless specified otherwise. One is a modified, detailed, or supplementary example of a part or the entirety of another.

When a specific number (inclusive of a number, numerical value, amount, range, and the like) is provided for an element in the following description, the number is not limited to the specific number and may be greater or smaller than the specific number except for explicitly specified cases or cases where the number is obviously limited to the specific number in principle.

Furthermore, it goes without saying that elements (inclusive of element steps) in the following description are not indispensable except for explicitly specified cases or cases where the element is obviously indispensable in principle.

The embodiments provided hereinafter are to exemplify network control apparatuses or network systems for implementing the technical idea of this invention and are not intended to limit this invention to the network control apparatuses or the network systems. Accordingly, this invention can be equally applicable to the network control apparatuses or the network systems of other embodiments within the scope of the claims.

### Embodiment 1

Embodiment 1 provides an example of control when an MME included in a mobile network system needs to perform different kinds of processing successively.

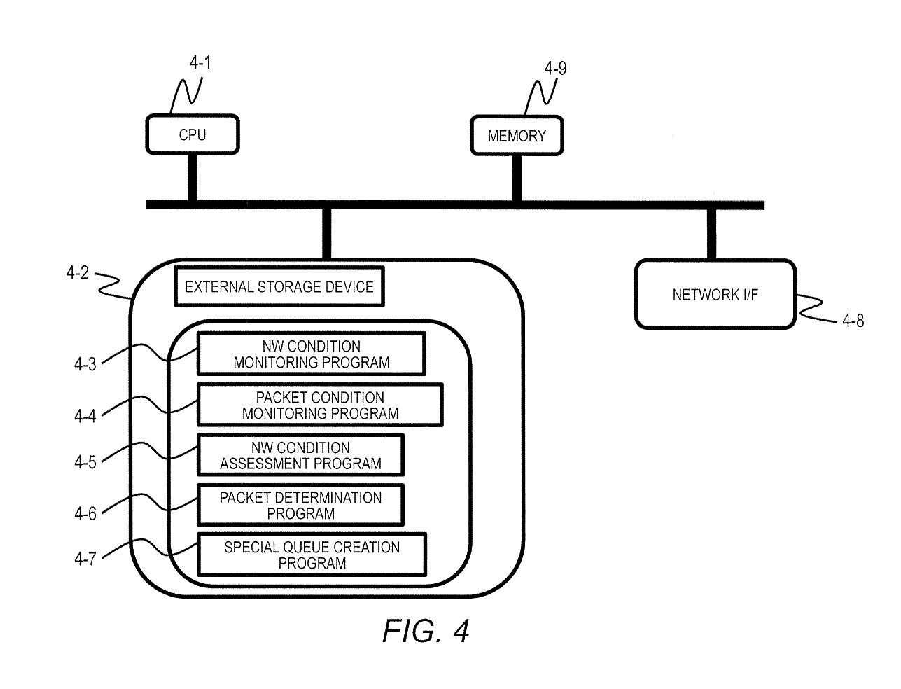

FIG. 4 is a diagram illustrating an example of hardware configuration of a network control apparatus in Embodiment 1.

This configuration includes a CPU 4-1, an external storage device 4-2, a network interface (I/F) 4-8, and a memory 4-9. The external storage device 4-2 includes a network (NW) condition monitoring program 4-3, a packet condition monitoring program 4-4, a network (NW) condition assessment program 4-5, a packet determination program 4-6, and a special queue creation program 4-7. These programs included in the external storage device 4-2 are loaded to the memory in accordance with an instruction of the CPU and run on the CPU.

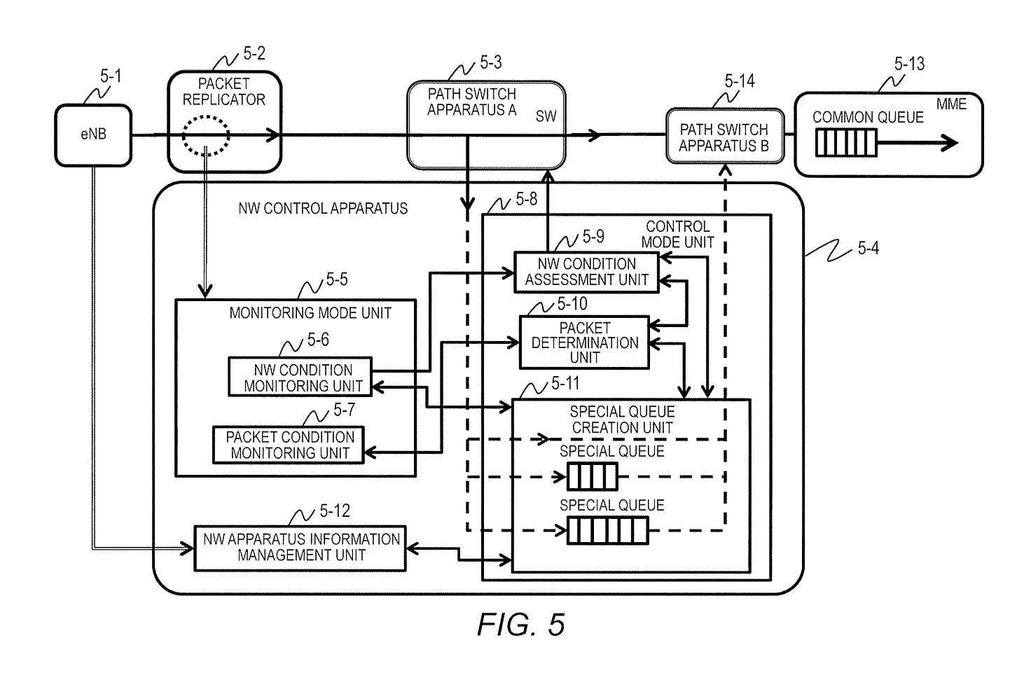

FIG. 5 is a diagram illustrating an example of the apparatus configuration and function blocks of a mobile network system to which this invention has been applied. The mobile network system includes an eNB and an MME. It should be noted that this invention is not limited to a mobile network system including an eNB and an MME but is also applicable to between network nodes included in a network. The system of FIG. 5 aims for network control between the eNB and the MME. For the network control, this system includes a packet replicator 5-2 for replicating packets, a path switch apparatus A 5-3 and a path switch apparatus B 5-14 for isolating packets from a common queue when the network condition is assessed as worse than normal, and a network control apparatus 5-4 for monitoring the network condition in normal times and starting controlling the traffic in response to detection of burst transmission.

When the network control apparatus 5-4 assesses the network condition as worse and issues an instruction to isolate packets from the common queue, the path switch apparatus A 5-3 switches the path for the packets from the path going through the switch apparatus B 5-14 to the path going through the network control apparatus 5-4.

When the network control apparatus 5-4 assesses the network condition as worse and issues an instruction to isolate packets from the common queue, the path switch apparatus B 5-14 switches from the path going through the path switch apparatus A 5-3 to reach the MME 5-13 into the path going through the network control apparatus 5-4 to reach the MME 5-13.

The network control apparatus 5-4 includes a monitoring mode unit 5-5 that operates all the time to monitor the network condition, a control mode unit 5-8 that activates upon determination that control is needed, and a network (NW) information management unit 5-12 for managing information on network apparatuses that send packets.

The monitoring mode unit 5-5 includes a network (NW) condition monitoring unit 5-6 for monitoring the condition of network traffic by packet type in normal times based on the packets received from the packet replicator 5-2 and a packet condition monitoring unit 5-7 having a table for recording packet processing names, message names, and message processing numbers of the received packets. A packet type corresponds to a procedure. For example, a first packet type corresponds to the S1_SETUP procedure and a second packet type corresponds to the Attach procedure. The procedures are determined based on packet types.

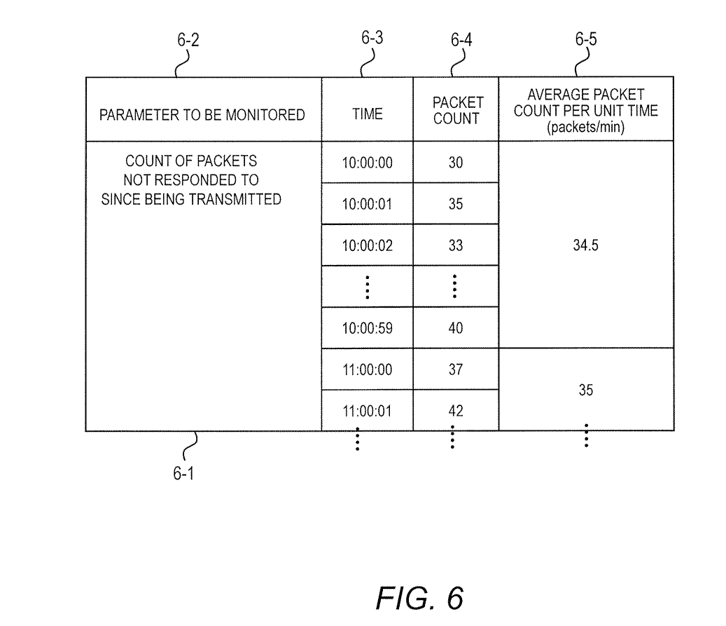

The NW condition monitoring unit 5-6 can be implemented using deep packet inspection (DPI) or other means. The condition monitoring monitors the count of packets not responded to since being transmitted, packet response times, and the count of packets received per unit time on a fine-grain basis and records the results regardless of whether the condition is normal or abnormal. FIG. 6 shows a monitoring result table 6-1 for the count of packets not responded to since being transmitted, by way of example. The monitoring result table 6-1 records packet counts 6-4 in individual time slots 6-3 and further, records average counts of packets 6-5 per unit time based on the recorded packet counts.

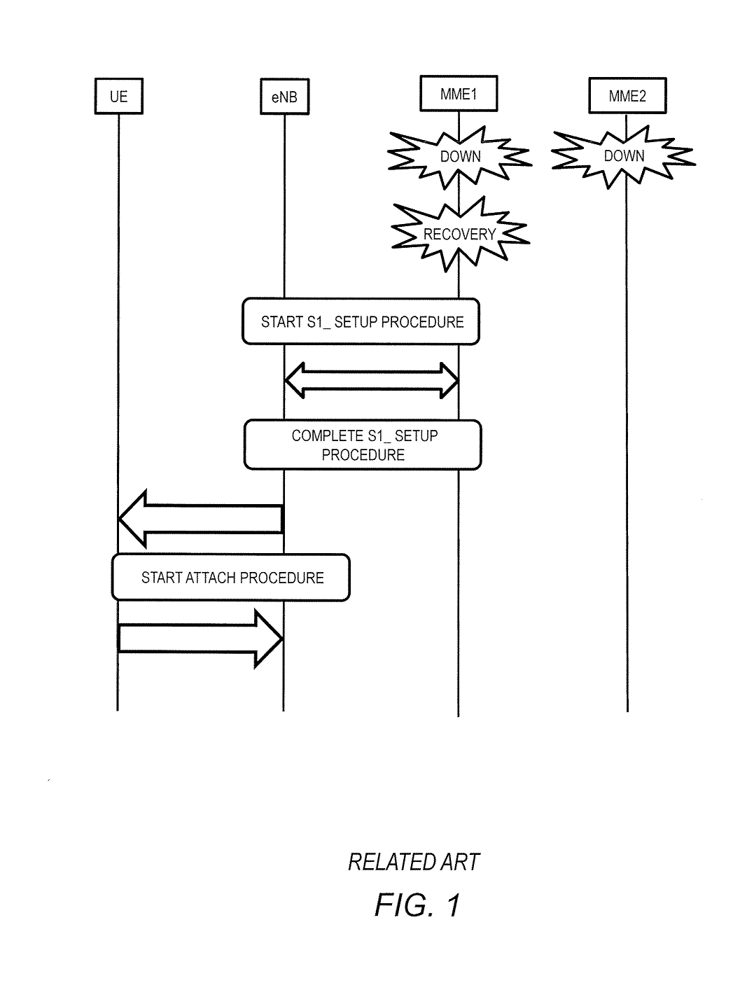

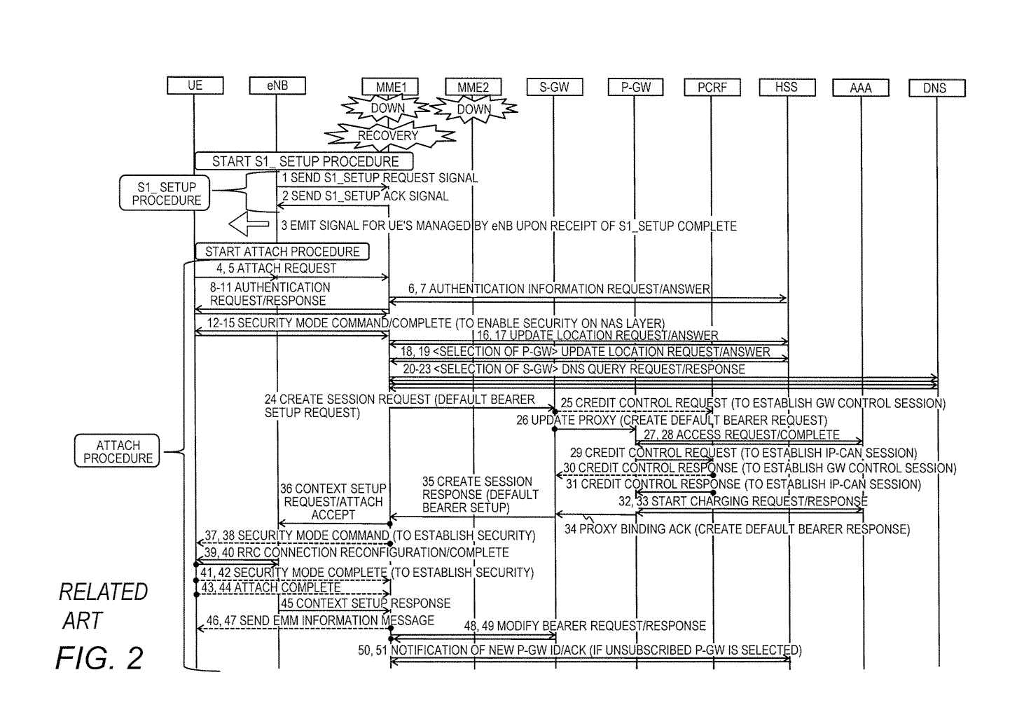

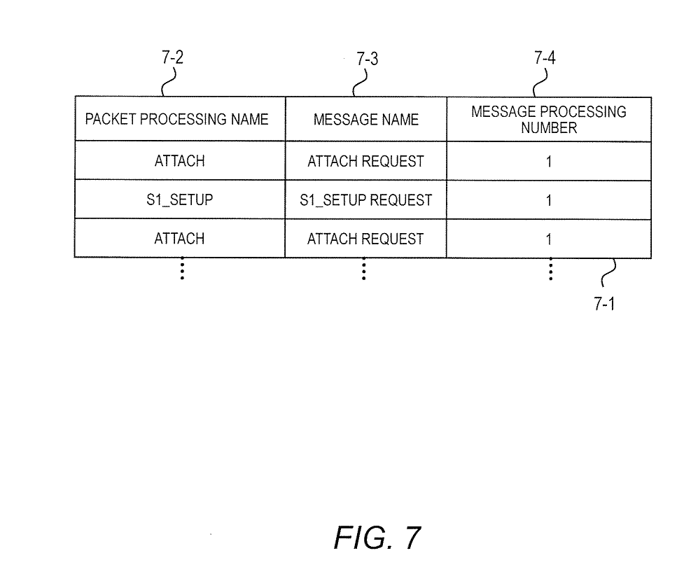

The packet condition monitoring unit 5-7 records packet processing names, message names, and message processing numbers. FIG. 7 shows a table 7-1, which is an example of a table storing such information. This table includes packet processing names 7-2 indicating processing being executed, message names 7-3 indicating names of messages, and message processing numbers 7-4 indicating numbers of the received messages among the messages in the processing being executed. The packet condition monitoring unit has information that the Attach procedure is started after completion of the S1_SETUP procedure and information on the sequences of the procedures as illustrated in FIGS. 1 and 2. Accordingly, the packet condition monitoring unit can identify the message processing number of a packet received from the packet replicator 5-2 by acquiring a packet type and a message name of the acquired packet.

The example in FIG. 7 indicates a case where an S1_SETUP procedure and an Attach procedure are to be performed successively. Accordingly, the table 7-1 stores the processing names for the received messages, “S1_SETUP procedure” and “Attach procedure”, in the column of packet processing names 7-2. Furthermore, the table 7-1 stores message names of the messages for the MME, “S1_SETUP request” and “Attach request”, in the column of message names 7-3 and numbers of the messages among the messages to be received until completion of the procedure in the column of message processing number 7-4.

The control mode unit 5-8 includes a network (NW) condition assessment unit 5-9 for assessing whether the network condition is different from normal, a packet determination unit 5-10 having a function of determining which message needs a special queue, and a special queue creation unit 5-11 for determining a maximum queue length and a service rate for the packets determined to be in need of a special queue. The control mode unit stores the selected packets in a special queue to delay the packets in reaching the MME by a predetermined time.

The messages which are not in need of a special queue are forwarded to the path switch apparatus B without being stored in the special queue as illustrated in FIG. 5.

The NW condition assessment unit 5-9 checks the condition between the eNB 5-1 and the MME 5-13 using the monitoring results of the NW condition monitoring unit 5-6.

In checking the condition, the NW condition assessment unit 5-9 assesses whether the network condition is worse based on the counts of packets not responded to since being transmitted, the packet response times, and the counts of packets received per unit time acquired at the NW condition monitoring unit 5-6. For example, the NW condition assessment unit 5-9 acquires the monitoring result table 6-1 from the NW condition monitoring unit 5-6. If the average count of packets per unit time 6-5 exceeds a predetermined value, the NW condition assessment unit 5-9 determines that the condition between the eNB 5-1 and the MME 5-13 has got worse than normal (the network quality has degraded). In the case of using the packet response time or the count of received packets per unit time as a parameter to assess the network condition, the network condition assessment unit 5-9 can likewise make assessment by comparing the response time or the packet count with a predetermined value.

When the NW condition assessment unit 5-9 determines that the condition between the eNB 5-1 and the MME 5-13 has got worse than normal (the network quality has degraded), the NW condition assessment unit 5-9 instructs the path switch apparatus A 5-3 to switch the path to go through the network control apparatus 5-4.

The packet determination unit 5-10 determines packets in need of a special queue with the data of the packet condition monitoring unit 5-7. First, the packet determination unit 5-10 checks whether different kinds of packet processing are requested.

For example, FIG. 7 indicates different kinds of processing, S1_SETUP procedure and Attach procedure, are requested. Hence, the packet determination unit 5-10 acquires the order of packet processing from the data held by the packet condition monitoring unit 5-7. Specifically, the packet determination unit 5-10 finds out that the Attach procedure is started after completion of the S1_SETUP procedure. To reduce the load to the MME sooner, the subsequent Attach procedure should be preceded; accordingly, the packet determination unit 5-10 determines that a special queue is needed for the S1_SETUP procedure. In this way, the subsequent packet processing is preceded based on the order of packet processing so that the older packets are delayed in reaching the MME.

The special queue creation unit 5-11 determines a queue length for the special queue for the packets determined by the packet determination unit 5-10 based on the service rate calculated from the average packet response time for the packets of the type and the timeout period for the packets of the type acquired from the NW information management unit 5-12 managing information on NW apparatuses that send packets. The timeout period means a time until making determination that the transmission is failed; packets taking longer than this time are discarded even if they arrive. The NW information management unit 5-12, for example, acquires the timeout period for each packet type from the eNBs that send packets in advance and holds the timeout periods in a table.

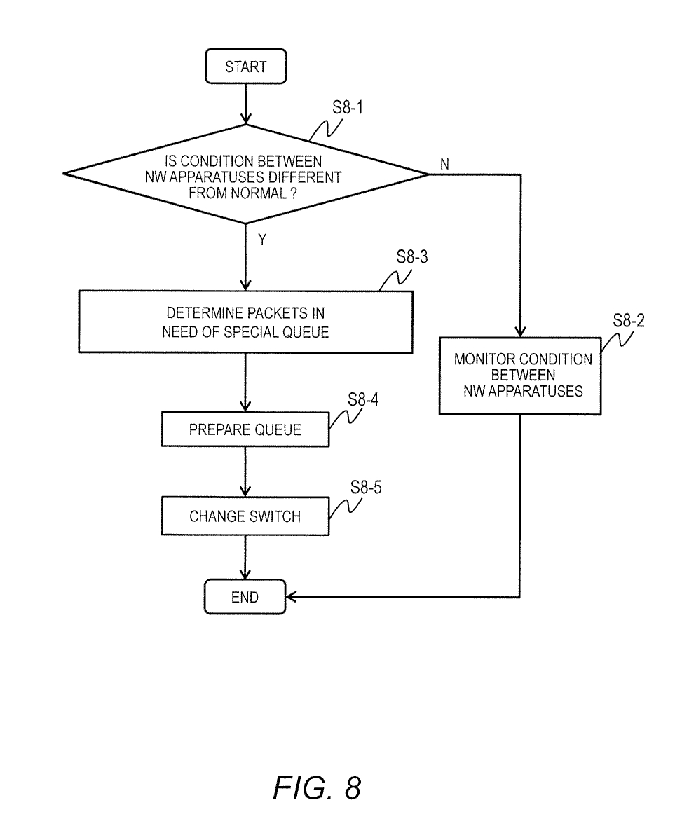

FIG. 8 is a flowchart illustrating an example of overall processing in the network control apparatus in Embodiment 1. Hereinafter, the processing is described step by step.

Step S8-1: The NW condition monitoring unit 5-6 in the monitoring mode unit 5-5 monitors packets replicated by the packet replicator 5-2 on a fine-grain basis. The NW condition assessment unit 5-9 in the control mode unit 5-8 uses the monitoring results to assess whether the condition between the eNB 5-1 and the MME 5-13 is worse than normal. Specifically, the NW condition monitoring unit 5-6 monitors counts of packets not responded to since being transmitted, packet response times, or counts of packets received per unit time. If the count of packets not responded to since being transmitted exceeds a predetermined value, if the measured response times are longer than a predetermined value, or if the count of packets received per unit time is smaller than a predetermined value, the NW condition assessment unit 5-9 determines that the condition between the network apparatuses has got worse than normal (the network quality has degraded) (Yes). In this case, the NW condition assessment unit 5-9 sends a signal notifying the packet determination unit 5-10 of switching packets (starting preparation for switching the path) to the control mode unit 5-8.

Step S8-2: If the count of packets not responded to since being transmitted is not more than a predetermined value, if the measured response times are not longer than a predetermined value, or if the count of packets received per unit time is not less than a predetermined value, the NW condition assessment unit 5-9 assesses the condition between the network apparatuses as normal (No). In this case, the NW condition assessment unit 5-9 keeps monitoring the condition between the eNB 5-1 and the MME 5-13. Since the condition between the eNB 5-1 and the MME 5-13 is normal, the NW condition assessment unit 5-9 does not instruct the path switch apparatus A 5-3 on anything.

Step S8-3: The packet determination unit 5-10 receives a signal to switch packets to the control mode unit 5-8 from the NW condition assessment unit 5-9. The packet determination unit 5-10 then determines packets in need of a special queue based on the data in the packet condition monitoring unit 5-7.

Specifically, the packet determination unit 5-10 checks whether different kinds of packet processing are requested. If different kinds of packet processing are requested, the packet determination unit 5-10 acquires the order of packet processing from the data held by the packet condition monitoring unit 5-7. Since subsequent packet processing needs to be preceded, the packet determination unit 5-10 determines that a special queue is necessary for the messages of older packets. The information on the packets or messages to be preceded is sent to the special queue creation unit 5-11 in the control mode unit 5-8.

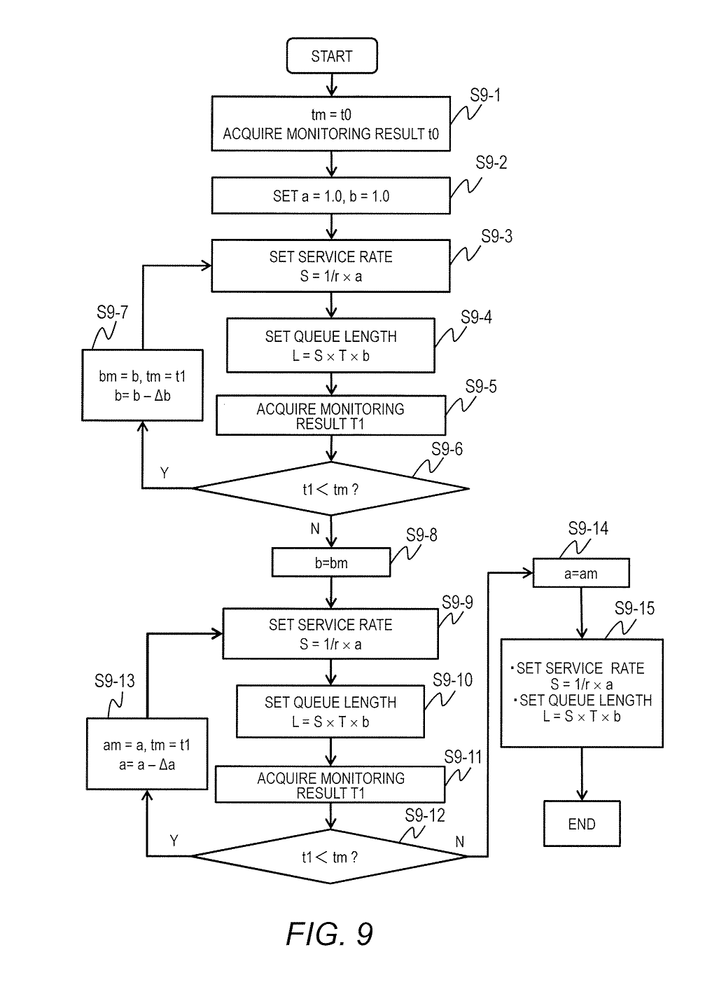

Step S8-4: The special queue creation unit 5-11 that has received the above-described information determines a service rate and the maximum queue length of the special queue for the determined packets and prepares the special queue. The determination of the service rate and the maximum queue length of the special queue will be described later in detail with FIG. 9. Upon completion of the preparation of the special queue, the special queue creation unit 5-11 sends a signal indicating the completion of the preparation of the special queue to the NW condition assessment unit 5-9. For the queue for the undesignated packets, the maximum queue length is determined to be zero; neither the service rate nor the queue length is determined.

Step S8-5: The NW condition assessment unit 5-9 that has received the signal indicating the completion of preparation of the special queue instructs the path switch apparatus B 5-14 to switch packets to be transferred to the control mode unit 5-8 and terminates the processing.

In this section, determination of the service rate for a special queue and the maximum queue length of the special queue are described in detail. First, the service rate for a special queue and the maximum queue length of the special queue are explained.

The service rate of a special queue is defined as the following Formula 1:

S=(1/r)×a Formula 1

where S represents the service rate of the special queue, r represents the average response time, and a is a coefficient. The service rate of a special queue is a speed a packet passes through the special queue. If a packet takes longer than the timeout period to pass through a queue having a determined queue length, the packet discard rate increases; accordingly, it is preferable that the time for a packet to pass through the queue be shorter than the timeout period. Therefore, the coefficient a is an attenuation coefficient not more than 1. Specifically, the service rate can be calculated using Formula 1 with the average response time of the packets of the type in normal condition measured by the NW condition monitoring unit 6.

Next, the maximum queue length of a special queue can be defined as the following Formula 2:

L=S×T×b Formula 2

where L represents the maximum queue length of the special queue, S represents the aforementioned service rate of the special queue, T represents a timeout period for the packets to be processed by the special queue, and b is a coefficient. As described above, if a packet takes longer than the timeout period to pass through a queue having the determined length, the packet discard rate increases; accordingly, it is preferable that the time for a packet to pass through the queue be shorter than the timeout period. Therefore, the coefficient b is an attenuation coefficient not more than 1. Specifically, the maximum queue length of the special queue can be calculated using Formula 2 with the timeout period for the packet type acquired from the NW information management unit 5-12 managing the information on NW apparatuses that send packets.

As described above, the maximum values of the service rate and the queue length for a special queue can be determined if the average response time r of the packets of the type in normal condition and the timeout period T for the packets of the type to be processed by the special queue (the maximum values are obtained when a=1 and b=1).

The Optimum values for the coefficients a and b depend on the network condition.

Now, determination of the service rate and the maximum queue length for a special queue is described in detail with FIG. 9. FIG. 9 is an example of the flowchart of the processing of seeking the optimum values for the service rate and the maximum queue length of a special queue in the network control apparatus.

Step S9-1: The special queue creation unit 5-11 defines the current response time for the special queue as tm with reference to the monitoring results of response time in the packet type acquired by the NW condition monitoring unit 5-6. Taking this value as an initial value, the special queue creation unit 5-11 first seeks the optimum value for the coefficient b.

Step S9-2: The special queue creation unit 5-11 assigns values to the coefficient a and b in Formulae 1 and 2 to determine the initial values of the service rate and the maximum queue length. To set maximum value for the service rate and the maximum queue length, the special queue creation unit 5-11 assigns 1 for the initial values of the coefficients a and b.

Step S9-3: The special queue creation unit 5-11 sets a service rate to the special queue. The service rate of the special queue is calculated using Formula 1 (coefficient a=1) with the value of response time r in the packet type in normal condition acquired from the NW condition monitoring unit 5-6.

Step S9-4: The special queue creation unit 5-11 sets a maximum queue length for the special queue. The maximum queue length of the special queue can be calculated using Formula 2 (coefficient b=1) with the service rate calculated at Step S9-3 and the timeout period T for the packets to be processed with the special queue.

Step S9-5: The special queue creation unit 5-11 acquires a monitoring result of the response time of a packet passed through the special queue when the service rate and the maximum queue length are set to the special queue from the NW condition monitoring unit 5-6. The result at this stage is defined as response time t1.

Step S9-6: The special queue creation unit 5-11 compares the response time t1 acquired at step S9-5 with the response time tm. If t1 is smaller than tm, the special queue creation unit 5-11 proceeds to Step S9-7 to determine the value for the coefficient b to attain a shortest response time.

Step S9-7: The special queue creation unit 5-11 substitutes the response time t1 obtained at Step S9-5 for tm and defines the value of the coefficient b when the response time t1 is obtained at Step S9-5 as bm. After subtracting a unit amount Δb from the value of the coefficient b, the special queue creation unit 5-11 returns to Step S9-3. The special queue creation unit 5-11 repeats the subsequent steps until t1 becomes greater than tm at Step S9-6.

Step S9-8: The special queue creation unit 5-11 adopts the value (bm) for the coefficient b when t1 takes the shortest value as the fixed value for b.

Step S9-9: The special queue creation unit 5-11 sets a service rate to the special queue. The service rate for the special queue is calculated using Formula 1 (coefficient a=1) with the value of the response time r of the packet of the type in normal condition acquired from the NW condition monitoring unit 5-6.

Step S9-10: The special queue creation unit 5-11 sets a maximum queue length to the special queue. The maximum queue length of the special queue is calculated using Formula 2 with the service rate calculated at Step S9-9 and the timeout period T for the packets to be processed in the special queue acquired from the NW information management unit 5-12. For the coefficient b, the value determined to be optimum and fixed at Step S9-8 is assigned.

Step S9-11: The special queue creation unit 5-11 acquires a monitoring result of the response time of a packet passed through the special queue when the service rate and the maximum queue length are set to the special queue from the NW condition monitoring unit 5-6. The result at this stage is defined as response time t1.

Step S9-12: The special queue creation unit 5-11 compares the response time t1 acquired at step S9-11 with the response time tm. If t1 is smaller than tm, the special queue creation unit 5-11 proceeds to Step S9-13 to determine the value for the coefficient a to attain a shortest response time.

Step S9-13: The special queue creation unit 5-11 substitutes the response time t1 obtained at Step S9-11 for tm and defines the value of the coefficient a when the response time t1 is obtained at Step S9-11 as am. After subtracting a unit amount Δa from the value of the coefficient a, the special queue creation unit 5-11 returns to Step S9-9. The special queue creation unit 5-11 repeats the subsequent steps until t1 becomes greater than tm at Step S9-12.

Step S9-14: The special queue creation unit 5-11 adopts the value (am) for the coefficient a when t1 takes the shortest as the fixed value for a.

Step S9-15: The special queue creation unit 5-11 calculates the service rate and the maximum queue length of the special queue using Formulae 1 and 2 with the values of a and b obtained in the foregoing steps.

### Embodiment 2

Embodiment 2 provides an example of control when the MME needs to perform the same kind of packet processing successively. The differences from Embodiment 1 are only the packet processing names, message names, and message processing numbers acquired by the packet condition monitoring unit 5-7 and the determination method in the packet determination unit 5-10, which are described hereinafter.

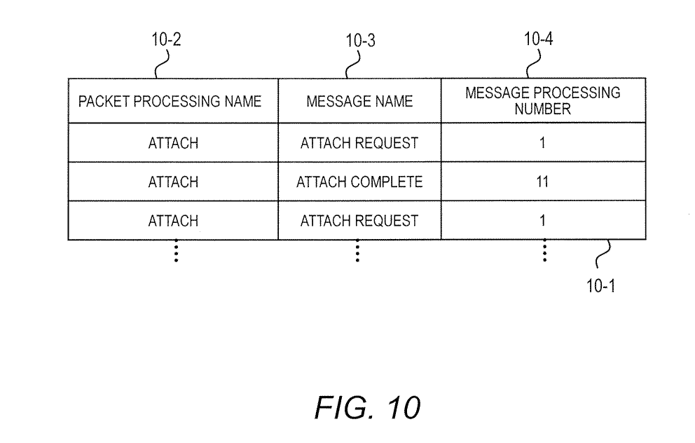

The packet condition monitoring unit 5-7 records packet processing names, message names, and message processing numbers. FIG. 10 shows a table 10-1, which is an example of a table storing such information.

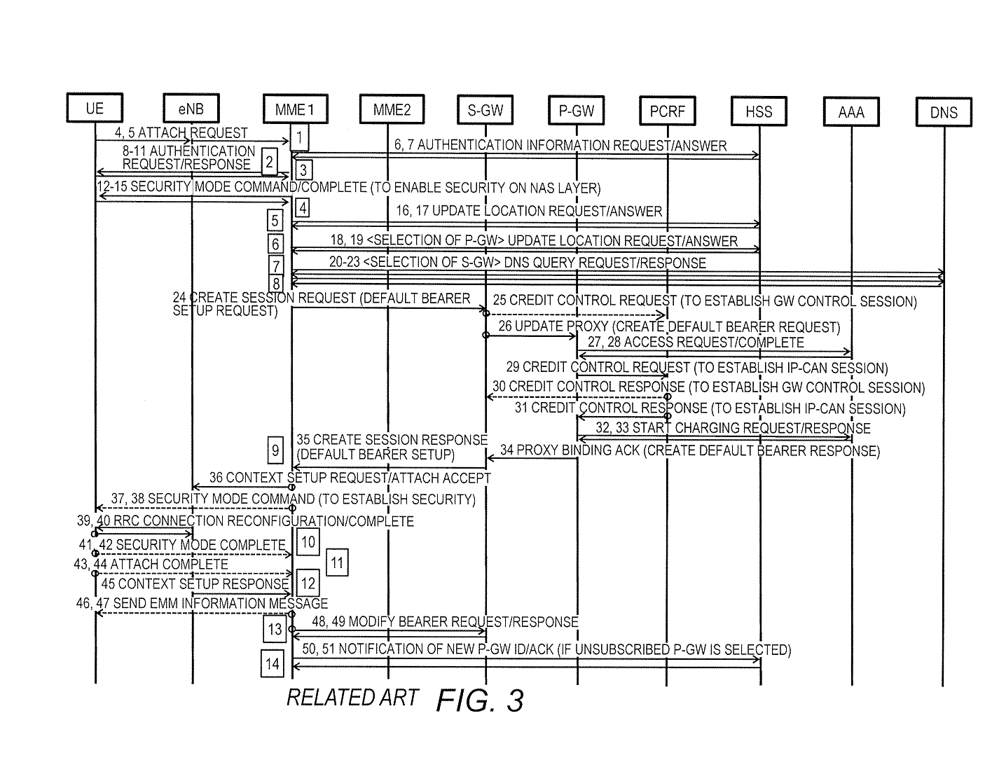

The packet processing names 10-2 in the table 10-1 stores values of “Attach procedure” of the processing names for the received messages; the message names 10-3 stores values of “Attach request”, “Attach complete”, and the like of the message names of the messages for the MME; and the message processing numbers 10-4 stores the numbers of the messages among the messages to be received until completion of the procedure. The message processing number is further described. The Attach procedure discussed in Embodiment 2 is performed in accordance with the sequence illustrated in FIG. 3. Since the control system of this example is installed between the eNB 5-1 and the MME 5-13, to be processed are the fourteen messages to be received by the MME. Accordingly, each message processing number 10-4 stores the number of a message among the fourteen messages that the MME receives until the completion of the Attach procedure. The packet condition monitoring unit knows the sequence of the Attach procedure illustrated in FIG. 3 in advance. Accordingly, the packet condition monitoring unit can identify the message processing number of a packet received from the packet replicator 5-2 by acquiring a packet type and a message name of the received packet.

The packet determination unit 5-10 determines packets in need of a special queue with reference to the data of the packet condition monitoring unit 5-7. First, the packet determination unit 5-10 checks whether different kinds of packet processing are requested. Since the same kind of packet processing is requested in Embodiment 2, the packet determination unit 5-10 cannot determine packets in need of a special queue only with the packet processing names. Accordingly, the packet determination unit 5-10 refers to the message processing numbers to find out the processing order of the messages.

The sequence of an Attach procedure illustrated in FIG. 3 indicates a message assigned a greater number is for a later stage of the procedure. Noting that preceding messages for a later stage completes the overall processing sooner among the same kind of procedures, the packet determination unit 5-10 determines messages assigned a greater number to be preceded and determines to create a special queue for the messages assigned a smaller number. That is to say, the messages assigned a smaller number are delayed in reaching the MME among a plurality of messages. As noted from this example, specific messages are delayed in reaching the MME based on not only the packet types but also the processing order of packets. This control can reduce the load to the MME sooner even if the MME needs to perform the same kind of packet processing successively.

### Embodiment 3

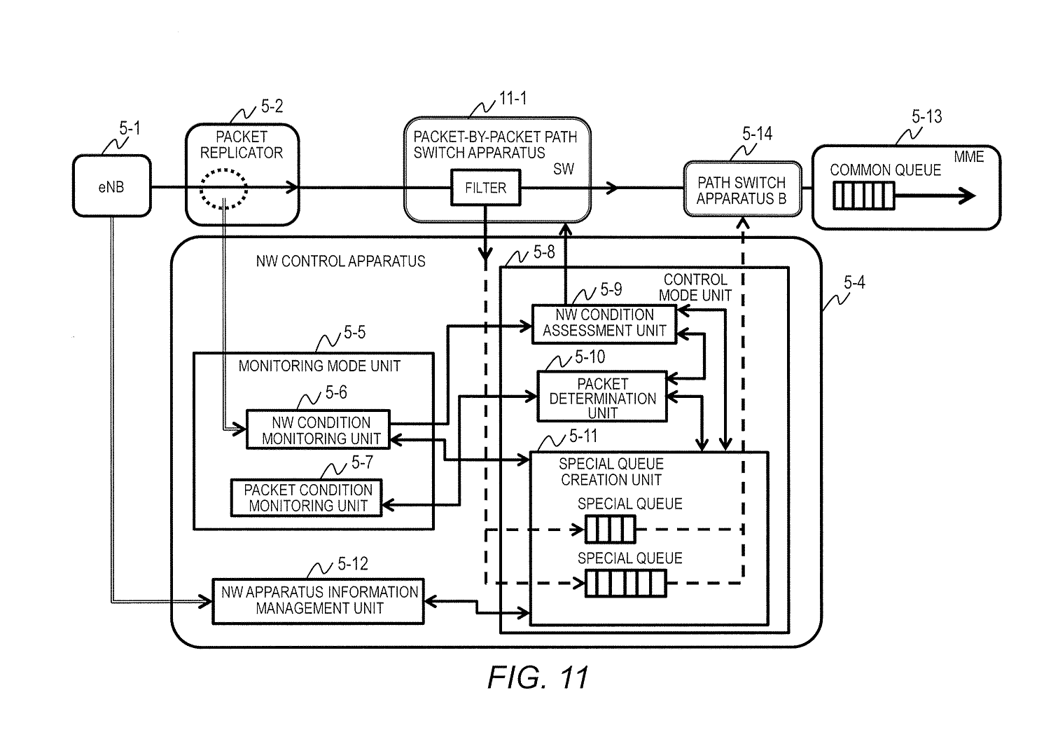

Next, an example of a communication service providing system in Embodiment 3 is described. FIG. 11 is a diagram illustrating an example of a network control apparatus in Embodiment 3. Embodiment 3 is different in the point that the path switch apparatus A 5-3 in Embodiments 1 and 2 is replaced by a packet-by-packet path switch apparatus 11-1. The other configuration is the same as those of Embodiments 1 and 2; the repeated description is omitted in this section.

The packet-by-packet path switch apparatus 11-1 switches the paths for only the packets determined by the packet determination unit 5-10 from the path switch apparatus B 5-14 to the network control apparatus 5-4 when the NW condition assessment unit 5-9 assesses the network condition as worse.

Specifically, the NW condition assessment unit 5-9 sends a signal notifying the packet determination unit 5-10 of switching packets (starting preparation for switching the path) when the NW condition assessment unit 5-9 determines that the condition between eNB 5-1 and the MME 5-13 is different from normal. The packet determination unit 5-10 that has received the signal determines packets in need of a special queue with the data of the packet condition monitoring unit 5-7 and sends the information on the determined packets to the packet-by-packet path switch apparatus 11-1.

The packet-by-packet path switch apparatus 11-1 that has received the information on the determined packets separates packets into packets to be forwarded to the network control apparatus 5-4 and packet not to be forwarded based on the information.

In this way, the packet-by-packet path switch apparatus 11-1 separates packets into packets to be forwarded to the network control apparatus 5-4 and packets not to be forwarded. Creating a special queue for the determined packets and separating the packets from the common queue achieve reduction in signaling. The packet determination unit 5-10 may be provided in either the control mode unit 5-8 or the packet-by-packet path switch apparatus 11-1.

What is claimed is:

1. A network control apparatus comprising:
a memory storing programs and data; and
a processor, by executing the programs, configured to:
acquire packets sent from a first network node to a second network node;
manage packet types of the packets;
monitor condition of a network between the first network node and the second network node based on the packets; and
delay a specific packet in reaching the second network node based on an order of procedures determined based on packet types in the second network node when the condition of the network is assessed as worse than normal.

2. The network control apparatus according to claim 1, wherein the processor is configured to delay packets of a first packet type in reaching the second network node when a procedure of the first packet type is before procedure of a second packet type in the second network node.

3. The network control apparatus according to claim 2, wherein the processor is configured to:
control a path switch apparatus to switch paths provided between the first network node and the second network node for the first packet;
create a special queue for storing packets of the first packet type to be input to the network control apparatus after the switching of the paths; and
determine a queue length of the special queue based on a service rate calculated from an average response time of packets of the first packet type and a timeout period of the first packet type.

4. The network control apparatus according to claim 1, wherein the processor is configured to monitor the condition of the network based on counts of packets not responded to since being transmitted, response times of packets, or counts of received packets per unit time.

5. The network control apparatus according to claim 1,
wherein a procedure of a packet type includes processing messages, and
wherein the processor is configured to delay a specific message in reaching the second network node based on the packet types and orders of messages to be processed in procedures in the second network node when the condition of the network is assessed as worse than normal.

6. The network control apparatus according to claim 5, wherein the processor is configured to delay a first message in reaching the second network node when the first message is to be processed before a second message in the second network node.

7. The network control apparatus according to claim 3, wherein the processor is configured to control the path switch apparatus to forward only packets of the first packet type to be stored in the special queue to the network control apparatus.

8. A network control method comprising:
acquiring packets sent from a first network node to a second network node;
monitoring condition of a network between the first network node and the second network node based on the packets; and
delaying a specific packet in reaching the second network node based on an order of procedures determined based on packet types in the second network node when the condition of the network is assessed as worse than normal.
